(19) United States
(12) Patent Application Publication
(10) Pub. No.: US 2017/0311603 A1
(43) Pub. Date: Nov. 2, 2017

(54) USE OF BISMUTH SUBSALICYLATE OR ONE OF THE DERIVATIVES THEREOF AS A PHYTOPHARMACEUTICAL AGENT

(71) Applicant: UNIVERSITE DE HAUTE-ALSACE, MULHOUSE CEDEX (FR)

(72) Inventors: CHRISTOPHE BERTSCH, AMMERSCHWIHR (FR); SEBASTIEN ALBRECHT, MULHOUSE (FR); CELINE TARNUS, RIXHEIM (FR); MELANIE GELLON, COLMAR (FR)

(21) Appl. No.: 15/522,788

(22) PCT Filed: Oct. 30, 2015
(86) PCT No.: PCT/FR2015/052932

§ 371 Date: Apr. 28, 2017

(30) Foreign Application Priority Data
Oct. 30, 2014 (FR) 1460451

(51) Int. Cl. A01N 55/02; C07F 9/94

(52) U.S. Cl. CPC A01N 55/02; C07F 9/94

(57) ABSTRACT

The invention relates to the use of bismuth subsalicylate or one of the derivatives thereof as a phytopharmaceutical agent, in particular for the treatment or prevention of fungal diseases in plants.

### FIELD OF THE INVENTION

The invention relates to the plant protection or phytosanitary field, particularly to the prevention and control of fungal diseases in plants, notably those affecting grapevines and fruit trees.

### TECHNOLOGICAL BACKGROUND

Controlling and preventing fungal diseases are major agricultural challenges, particularly in the fields of viticulture and arboriculture. There exist various types of fungal diseases, such as powdery mildew, gray rot, and wood diseases which include esca, Botryosphaeria dieback (such as black dead arm), Eutypa dieback, anthracnose and dead-arm disease.

Wood diseases are particularly detrimental to viticulture longevity. The parasites responsible for these diseases cause, in the more or less long term, the death of the grapevine stock and may require more than 10% of a vineyard to be replanted with seedlings.

The past 10 years or so have seen a worrying spread of these diseases, which have become major concerns of the wine producing industry. Indeed, vineyards around the world have been affected. In France, all the wine-producing areas are affected and currently about 13% of French vineyards are unproductive, chiefly because of these dieback diseases. Several observations suggest that the epidemic is only at the beginning of a cycle: i) the banning of sodium arsenite, the only effective means known to date for controlling esca and black dead arm (BDA), as of 2001, ii) the 4% to 5% annual increase in death rate as of the fifth year following cessation of sodium arsenite treatment and iii) the high rate of asymptomatic grapevine stocks contaminated in the vineyard.

Indeed, the development of this epidemic has been promoted by the banning of sodium arsenite in 2001, in all wine-producing countries, due to its toxicity. This ban is all the more troubling for wine producers since no effective and viable alternative method has been proposed to date. This puts at risk the preservation and the longevity of the production base, on a worldwide scale. Consequently, the effects of these wood diseases will be numerous in the medium term: they will lead either to a lower quality of wines if plots are rejuvenated, or to a loss of the typicality of a wine of a wine-producing region if the most sensitive grape varieties are not replanted.

The wood diseases affecting vineyards include Eutypa dieback, esca, and certain Botryosphaeria dieback diseases such as black dead arm (BDA). These diseases are associated with the presence of various fungi capable of damaging woody tissues. The principal isolated species associated with these diseases are Phaeomoniella chlamydospora, Phaeoacremonium aleophilum, Eutypa lata, Fomitiporia mediterranea, Diplodia seriata, Neofusicoccum parvum and Botryosphaeria stevensii. Other species are still being identified.

These diseases are expressed in the wood by the formation of sector-based and/or central necrosis, by the presence of brown bands or cankers on the trunk and arms and of discoloration and drying of the leaves, which can be devastating.

Wood diseases can also cause stunting of the branches and symptoms in the fruits such as delayed maturation, dieback, or the presence of purplish-black spots on the fruit surface. Eutypa dieback, the principal pathogen of which is E. lata, affects not only vineyards but also fruit trees such as plum trees, pear trees, apple trees, apricot trees and cherry trees, and certain forest trees

Since the banning of sodium arsenite because of its high toxicity, research has been undertaken in several countries around the world to identify alternative solutions to its use. The combined use of cyproconazole and carbendazim has thus been proposed for preventing infections by Eutypa lata. This combination, marketed in France under the name Atemicep®, was withdrawn from the market due to its phytotoxicity. Another phytosanitary product combining flusilazole and carbendazim and approved for esca was also withdrawn from the market in 2007 due to its toxicity. Other chemical treatments are described in Bertsch et al., Plant Pathology, 2013, 62, 243-265.

Research is concentrating at present on the discovery of alternative solutions to the use of chemical agents. For example, the biofungicide ESQUIVE® WP, marketed by Bayer, has just been approved against esca, black dead arm and Eutypa dieback of grapevine. This phytopharmaceutical product is based on the use of a fungus, namely Trichoderma atroviride strain I-1237. This fungus has an antagonistic and hyperparasitism activity which would prevent the development of the principal phytopathogens involved in these diseases. This biofungicide must be applied, at the time of pruning, only prophylactically, by brushing or spraying. The efficacy of ESQUIVE® WP being partial, and demonstration in the field not being fully established, it is recommended to accompany its use with prophylactic cultivation measures.

New practices have also been developed for preventing the spread of wood disease during the production of seedlings in a nursery. Certain nursery operators treat the propagation material with warm water or in baths containing benomyl, captan or didecylmethylammonium chloride. These treatments make it possible to reduce the incidence of certain pathogens involved in wood diseases. The efficacy of these methods in terms of protecting grapevine seedlings remains a much-debated question.

Fungal diseases also affect many other plant species of agricultural interest, particularly cereal, crucifer, fruit and vegetable crops, as well as the products derived from these crops.

Thus, there remains today a need for new phytopharmaceutical agents, which respect the environment, for preventing and treating fungal diseases in plants.

### SUMMARY OF THE INVENTION

An object of the invention is the use of a compound of formula (I)

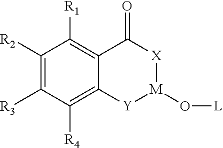

wherein
R₁, R₂, R₃ and R₄ are independently selected from the group consisting of a hydrogen, a halogen, preferably —Cl, —Br or —F, —OH, —O(CO)—CH₃, a C₁-C₆ alkoxy, a C₁-C₆ alkyl, —NH₂ and —CN,
X and Y are independently of each other O, S or NR₅,
M is Bi, Cu or Sb,
L is H or a vectorization moiety comprising from 1 to 40 carbon atoms, and
each R₅ group is independently H or a C₁-C₆ alkyl,
   or one of the acceptable salts thereof, as a phytopharmaceutical agent for preventing or treating a fungal disease in a plant, said fungal disease being associated with or caused by one or more phytopathogenic fungi selected from the parasitic basidiomycetes and the parasitic ascomycetes.

In certain embodiments, the compound of formula (I) is characterized in that:
R₁ and R₃ are —H,
R₂ and R₄ are independently selected from —H, —Cl and —F,
X and Y are O,
M is Cu or Bi, preferably Bi, and
L is H, a C₁-C₆ hydroxyalkyl, or —(CH₂—CH₂—O)ₙ—CH₂—CH₂—OH where n is an integer ranging from 1 to 19, preferably from 1 to 10.

A preferred compound is bismuth subsalicylate.

More precisely, the compound according to the invention may be used for treating or preventing a disease, preferably a fungal disease, in a plant. The plant may be of any type. It may be a woody or herbaceous plant. The plant may be selected from fruit trees, grapevines, plants of the family Solanaceae, plants of the family Apiaceae, crucifers, cereals and other grasses.

The disease may develop in the wood or in the aerial parts of the plant such as the fruits, the stems, the leaves, the flowers, the panicles, the ears and the seeds.

In certain embodiments, the fungal disease is caused by or associated with at least one fungus selected from the phytopathogens belonging to the genera Verticillium, Alternaria, Fusarium, Magnaporthe, Monilia, Penicillium, Botrytis, Hemileia, Cercospora, Mycosphaerella, Bipolaris, Gaeumannomyces, Eutypa, Phaeomoniella, Phaeoacremonium, Phomopsis, Fomitiporia and Stereum and the phytopathogens belonging to the family Botryosphaeriaceae, notably to the genera Spencermatinsia, Neofusicoccum, Botryosphaeria, Diplodia and Lasiodiplodia.

For example, the fungal disease may be caused by, or associated with, one of the following phytopathogenic species: Phaeomoniella chlamydospora, Phaeoacremonium aleophilum, Eutypa lata, Fomitiporia mediterranea, Fomitiporia punctata, Botryosphaeria stevensii, Diplodia seriata, Neofusicoccum parvum, Stereum hirsutum, Verticillium longisporum, Verticillium dahliae, Verticillium albo-atrum, Magnaporthe grisea, Monilinia fructigena, Monilinia laxa, Penicillium digitatum, Botrytis cinerea, Septoria dauci, Septoria lycopersici, Septoria tritici, Fusarium graminearum, Fusarium nivale, Alternaria triticina, Alternaria alternata, Alternaria dauci, Alternaria solani, Alternaria brassicicola, Alternaria brassicae, Guignardia bidwellii, Botryosphaeria dothidea, Botrytis cinerea, Cercospora beticola, Cercospora zeae-maydis, Cercospora zeina, Mycosphaerella fijiensis, Bipolaris oryzae, Bipolaris maydis, Bipolaris zeicola, Bipolaris sorokiniana, Gaeumannomyces graminis, Hemileia vastatrix and Hemileia coffeicola.

In certain embodiments, the fungal disease is selected from the group consisting of alternariosis, fusariosis, septoriosis, verticilliosis, pyriculariosis, brown rot (Monilia), rust caused by parasitic fungi of the order Pucciniales, cercosporiosis, helminthosporiosis, take-all disease, rot and mold diseases of the fruit, notably gray rot, black rot, Macrophoma rot, esca, Botryosphaeria dieback, Diplodia-cane dieback, Botryosphaeria canker, Eutypa dieback, anthracnose and dead-arm disease.

By way of example, the fungal disease may be selected from alternariosis, fusariosis, septoriosis, verticilliosis, pyriculariosis, brown rot, gray rot and Botryosphaeria dieback, notably black dead arm.

In certain embodiments, the fungal disease is selected from a rot or mold disease of the fruit and/or leaves, preferably associated with one or more pathogens selected from the genus Botrytis, notably Botrytis cinerea, the family Botryosphaeriaceae, and the parasitic oomycetes, notably Plasmopara viticola.

In other embodiments, the disease is a fungal disease of the wood associated with one or more pathogens selected from the pathogens belonging to the family Botryosphaeriaceae, to the genus Eutypa, for example Eutypa lata, to the genus Phaeomoniella, to the genus Phaeoacremonium, to the genus Formitiporia, to the genus Verticillium, to the genus Stereum or to the genus Phomopsis. By way of example, the wood disease may be associated with a pathogen selected from Phaeomoniella chlamydospora, Phaeoacremonium aleophilum, Eutypa lata, Fomitiporia mediterranea, Fomitiporia punctata, Botryosphaeria stevensii, Diplodia seriata, Neofusicoccum parvum, Stereum hirsutum and Verticillium longisporum.

In a preferred embodiment, the compound according to the invention is used for treating or preventing a grapevine fungal disease selected from the group consisting of esca, Eutypa dieback, Botryosphaeria dieback, notably black dead arm, black rot, dead-arm disease, anthracnose and gray rot.

In certain embodiments, the compound according to the invention may be used:
for preventing or treating infections of pruning wounds, notably in fruit trees and grapevines,
for disinfecting propagation or multiplication material, notably during the preparation of seedlings, preferably of grapevine seedlings, in a nursery, or
for preventing or treating rot or mold in crop products, notably in fruits.

Another aspect according to the invention is a phytopharmaceutical composition, preferably for treating or preventing a fungal disease in a plant as defined above, said composition comprising a compound of formula (I) and a phytopharmaceutically acceptable excipient. Said composition may comprise:
from 0.01% to 50% by weight of a compound of formula (I) as defined above, and
from 50% to 99.99% by weight of one or more phytopharmaceutically acceptable excipients,
   the weight percentages being expressed in relation to the total weight of the composition.

Said composition may comprise at least one excipient selected from a filler, a diluent, a thickener, a carrier and a surfactant.

Moreover, said composition may comprise an additional active agent selected from an additional phytopharmaceutical agent, a fertilizing agent or a fertilizer.

Lastly, the invention also relates to a method for treating or preventing a disease, preferably a fungal disease, in a plant, said method comprising applying the compound of formula (I) or a phytopharmaceutical composition as defined above on at least a part of said plant.

### FIGURES

FIG. 1 shows the mycelial growth of N. parvum on Petri dishes containing PDA medium supplemented with bismuth oxide, bismuth subsalicylate, bismuth citrate, copper oxide or antimony oxide at concentrations ranging between 0.01 and 40 mM.

The results correspond to the growth rates of the mycelium in relation to the control condition where the fungus was grown on pure PDA medium (100% growth).

FIG. 2 shows the mycelial growth of B. cinerea on Petri dishes containing PDA medium supplemented with bismuth oxide, bismuth subsalicylate, bismuth citrate, copper oxide or antimony oxide at concentrations ranging between 0.01 and 40 mM.

The results correspond to the growth rates of the mycelium in relation to the control condition where the fungus was grown on pure PDA medium (100% mycelial growth).

FIG. 3 shows the development of necrosis following inoculation with N. parvum Bourgogne of green internodes of V. vinifera cv. Chardonnay having first been subjected to a 15 mM bismuth oxide, salicylic acid or bismuth subsalicylate bath or a water bath (control) for 10 minutes. The results were calculated as a function of the areas of necrosis observed under the control condition (=100%).

FIG. 4 shows the expression of the defense genes VvPR1 and VvEDS1 (encoding enzymes of the salicylic acid pathway) in calli of V. vinifera cv. Chardonnay grown on MPM1 medium supplemented with 10 mM salicylic acid or bismuth subsalicylate. Gene expression was evaluated by RT-qPCR after 4 days of culture.

The results represent the relative expression of the genes in calli grown on supplemented medium compared with that which is observed in calli grown on non-supplemented MPM1 medium (control).

### DETAILED DESCRIPTION OF THE INVENTION

An object of the invention is novel methods for preventing and treating fungal diseases in plants. These methods are based on the use of bismuth subsalicylate or one of the derivatives thereof.

Bismuth subsalicylate is used in human medicine for treating and preventing gastrointestinal disorders. It is the active ingredient of the drugs Pepto-Bismol® and Kaopectate® marketed for, among other things, treating nausea, mild diarrhea and indigestion. Its maximum absorption dosage for digestive problems in humans is 500 mg/day.

Old, isolated studies dating from the 1940s mentioned the use of bismuth subsalicylate for treating blue mold disease of tobacco (Clayton et al., Journal of Agricultural Research, 1943, 66, 261, abstract). Blue mold diseases are caused by filamentous microorganisms that are not fungi, but oomycetes. The oomycetes belong to the phylum of the heterokonts and are, from a phylogenetic point of view, close to photosynthetic organisms such as brown algae and diatoms. They have no common ancestor with the Eumycota.

To the knowledge of the Inventors, the use of bismuth subsalicylate as a phytopharmaceutical or phytosanitary agent for treating or preventing a fungal disease, particularly caused by a parasitic fungus belonging to the basidiomycetes or the ascomycetes, has never been disclosed heretofore.

Surprisingly, the Inventors showed that bismuth subsalicylate is capable of significantly inhibiting the mycelium growth of several phytopathogens, in particular Neofusicoccum parvum, involved in Botryosphaeria dieback, and Botrytis cinerea, involved in gray fruit rot (also called “gray mold or rot”). The Inventors also showed that bismuth oxide and bismuth subcitrate, in turn, have a very weak inhibitory activity with respect to these phytopathogens.

The results obtained in vitro were confirmed in vivo on a model of necrosis on wood internodes of the Chardonnay grapevine variety. Preliminary soaking of a wood internode inoculated with N. parvum mycelium in a 15 mM solution of bismuth subsalicylate for 10 min made it possible to limit in a very significant manner 50%) the formation and propagation of necrosis and thus mycelial development. Such a result was not observed for preliminary soaking in a 15 mM salicylic acid bath or in a 15 mM bismuth oxide bath. The Inventors also showed that bismuth subsalicylate is capable of inducing certain of the plant's phytopathogen defense and resistance genes. Supplementary tests showed that bismuth subsalicylate is also capable of inhibiting in vitro the mycelial growth of several model phytopathogenic fungi involved in various plant pathologies such as alternariosis, fusariosis, septoriosis of wheat, fruit mold or rot, notably citrus fruit mold or rot, pyriculariosis, brown rot or verticilliosis. Notably, the biocidal effect of bismuth subsalicylate on phytopathogenic fungi is far superior to that which the Applicant was able to observe in two model oomycetes. Such a result shows that the biocidal effect of bismuth subsalicylate is specific to phytopathogenic fungi, notably the parasitic basidiomycetes and ascomycetes, and that this could not be anticipated from the former studies concerning blue mold disease of tobacco.

The experimental results disclosed in the present application illustrate the phytopharmaceutical properties of bismuth subsalicylate with respect to fungal infections and its capacity to penetrate wood. Bismuth subsalicylate has, moreover, the advantage of having particularly low toxicity to humans. It also has low environmental toxicity, as the Applicant showed through ecotoxicity experiments.

Bismuth subsalicylate is thus particularly suitable for use as a phytopharmaceutical agent for treating and preventing fungal diseases in plants, in particular plants of agricultural interest.

Thus, an object of the invention is the use of bismuth subsalicylate or one of the derivatives thereof as a phytopharmaceutical agent for treating or preventing fungal disease in a plant. “Bismuth subsalicylate” or “bismuth subsalicylate” is understood to mean the compound of the following formula:

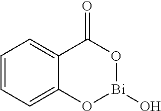

Within the meaning of the invention, by “fungal disease” is meant a disease caused by, or associated with, one or more phytopathogenic fungi. Within the meaning of the invention, the term “fungal disease” also includes diseases promoted by colonization of the plant by one or more saprophytic fungi.

On the other hand, the expression “fungal disease” does not include pathologies caused by phytopathogenic microorganisms that are not fungi. Notably, the expression “fungal disease” does not include pathologies caused by or associated with one or more phytopathogens belonging to the oomycetes such as Peronospora tabacina, Plasmopara viticola or Phytophtora infestans. In other words, downy mildew-type diseases such as blue mold disease of tobacco, grapevine downy mildew or potato blight are not included in the expression “fungal disease” according to the invention.

Within the meaning of the invention, fungal diseases include, but are not limited to, esca, Eutypa dieback, Botryosphaeria dieback, black rot, gray rot, anthracnose, dead-arm disease, alternariosis, fusariosis, septoriosis, fruit mold or rot, notably citrus fruit mold or rot, pyriculariosis, brown rot or verticilliosis.

In a preferred embodiment, the fungal disease is associated with or caused by one or more phytopathogenic fungi, in particular a microscopic phytopathogenic fungus, selected from the parasitic basidiomycetes and the parasitic ascomycetes.

The parasitic basidiomycetes include, but are not limited to, the phytopathogenic fungi of the genus Fomitiporia, Stereum and of the order Pucciniales, notably of the genus Hemileia.

The parasitic ascomycetes include, but are not limited to, the phytopathogenic fungi belonging to the genera Verticillium, Alternaria, Fusarium, Magnaporthe, Monilia, Penicillium, Aspergillus, Botrytis, Eutypa, Phaeomoniella, Phaeoacremonium, Phomopsis, Cercospora, Mycosphaerella, Bipolaris or to the family Botryosphaeriaceae, notably to the genera Spencermatinsia, Neofusicoccum, Botryosphaeria, Diplodia and Lasiodiplodia. The ascomycetes also include the phytopathogenic fungi responsible for powdery mildew. These phytopathogenic fungi belong to the family Erysiphaceae, notably to the genera Erysiphe, Podosphaera, Sphaerotheca and Uncinula, for example Erysiphe necator.

By way of example, the fungus or fungi belonging to the parasitic ascomycetes or to the parasitic basidiomycetes may be selected from the genera Alternaria, Fusarium, Septoria, Verticillium, Magnaporthe, Monilinia, Penicillium, Aspergillus, Septoria, Botrytis and Neofusicoccum.

By phytopathogenic fungus “associated with, involving or causing a disease” is meant a phytopathogenic fungus capable by itself of inducing the disease, and/or of promoting the development of the disease and/or of one of the symptoms thereof in the plant in question. Preferably, the phytopathogenic fungus is not pathogenic to the animal kingdom, particularly to mammals, including humans.

By way of example, the fungal disease may be associated with, or caused by, one or more microorganisms belonging to the family Botryosphaeriaceae.

In certain embodiments, the fungal disease is associated with or caused by one or more pathogens belonging to the family Botryosphaeriaceae. Within the meaning of the invention, such diseases include Botryosphaeria dieback diseases and pathologies affecting the aerial parts of plants and involving one or more phytopathogens of the family Botryosphaeriaceae, notably black rot and Macrophoma rot.

Within the meaning of the invention, the expression “Botryosphaeria dieback” refers to the fungal diseases involving one or more phytopathogens belonging to the family Botryosphaeriaceae and which can affect the woody parts of the plant. Botryosphaeria dieback diseases include wood diseases such as black dead arm, Diplodia-cane dieback and Botryosphaeria canker.

The fungal diseases involving a phytopathogen belonging to the family Botryosphaeriaceae and concerning grapevines are described notably in Úrbez-Torres, Phytopathol. Mediterr., 2011, 50 (Supplement), S5-S45, the content of which is incorporated herein by reference. Within the meaning of the invention, by “treating a disease” is meant the fact of treating, attenuating, slowing down or stopping the progression of a disease or one of the symptoms thereof in a plant. More precisely, by “treating” is meant the fact of stopping, slowing down, decreasing, controlling or suppressing the infection of the plant by a phytopathogenic fungus.

By “preventing a disease” is meant the fact of preventing or delaying the appearance of a disease or one of the symptoms thereof in a plant, the fact of slowing down, decreasing or preventing the spread of a disease in a given crop, the fact of eradicating or decreasing the presence of latent phytopathogens in a plant or crop, or the fact of decreasing the incidence of a disease or the risk of contamination by this disease within a given crop.

Within the meaning of the invention, by “phytopharmaceutical or phytosanitary agent” is meant a compound intended to protect plants and crop products against pests, particularly microorganisms, or to prevent the action thereof, to ensure the preservation of plant products, and/or to exert an action on the life processes of plants (insofar as it is not a nutritive substance), for example by promoting plant growth or by stimulating plant defenses.

Within the meaning of the invention, by “phytopharmaceutical or phytosanitary agent” is meant, preferably, a compound suited to agricultural use for treating or preventing a disease, preferably caused by a parasitic microorganism, in a plant organism. Such a phytopharmaceutical agent may have a direct effect on the development and viability of the microorganism(s) involved in or associated with the disease and/or induce or stimulate the mechanisms of resistance and of defense of the plant against said microorganism(s).

Preferably, within the meaning of the invention, the compounds of formula (I) as defined below exhibit an activity selected from a fungistatic activity, a fungicidal activity, a plant defense stimulatory activity and combinations thereof. Preferably, the compounds of formula (I) exhibit both a fungistatic activity and a plant defense stimulatory activity.

Within the meaning of the invention, by “fungistatic agent” is meant a compound capable of preventing, slowing down or stopping the development and/or reproduction of a phytopathogenic fungus.

Within the meaning of the invention, by “plant” is meant a multicellular vegetal organism of any type. Preferably, the plant is a vascular plant, i.e., a plant belonging to the tracheophytes. Vascular plants include woody plants and herbaceous plants. Preferably, the plant is of agricultural interest. It may be, for example, a vegetable, a fruit, a cereal or a viticultural crop. In certain embodiments, the plant is a woody plant. By way of example of woody plants, mention may be made of fruit trees such as banana trees, apricot trees, mango trees, plum trees, peach trees, apple trees, pear trees, cherry trees, quince trees, walnut trees, fig trees and citrus trees, forest trees, ornamental or horticultural trees and shrubs such as rosebushes, cotton, coffee and grapevines.

In other embodiments, the plant is an herbaceous plant. By way of example of herbaceous plants, mention may be made of plants of the family Solanaceae such as tomato and potato, plants of the family Apiaceae such as carrot or parsnip, crucifers (or the family Brassicaceae) such as rapeseed, grasses such as sugarcane, and cereals such as corn, rice, wheat, barley, oats and rye.

More precisely, the invention has as an object the use of a compound of formula (I)

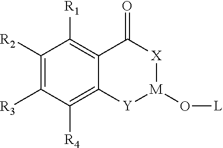

wherein
R₁, R₂, R₃ and R₄ are independently selected from the group consisting of a hydrogen, a halogen, —OH, —O(CO)—CH₃, a C₁-C₆ alkoxy such as —OCH₃, a C₁-C₆ alkyl, —NH₂, —CF₃ and —CN,
X and Y are independently of each other O, S or NR₅,
M is Bi, Cu or Sb,
L is H or a vectorization moiety comprising from 1 to 40 carbon atoms, and
each R₅ group is independently H or a C₁-C₆ alkyl,
   or one of the phytopharmaceutically acceptable salts thereof,
   as a phytopharmaceutical agent, for treating or preventing fungal disease in a plant, said fungal disease being associated with or caused by one or more phytopathogenic fungi selected from the parasitic basidiomycetes and the parasitic ascomycetes.

A C₁-C₆ alkyl includes, but is not limited to, the groups methyl, ethyl, propyl, butyl, pentyl, hexyl, isopropyl, tert-butyl, iso-butyl, sec-butyl, cyclopropyl, cyclobutyl, cyclopentyl and cyclohexyl. The preferred alkyl groups according to the invention are the C₁-C₃ groups, particularly the groups methyl, ethyl, propyl and isopropyl.

A C₁-C₆ hydroxyalkyl group refers to a C₁-C₆, preferably a C₁-C₃, alkyl group substituted by at least one hydroxyl.

A C₁-C₆ alkoxy group refers to an R—O— group where R is a C₁-C₆, preferably a C₁-C₃, alkyl group. The halogen atoms include —F, —Br, —Cl and —I. The preferred halogen atoms according to the invention are —F and —Cl.

By “vectorization moiety” is meant a chemical group that promotes the properties of the compound, notably the solubility of the compound in water and/or its ability to penetrate wood. The vectorization moiety may comprise, among other things, a glycosyl radical and/or a hydrocarbon chain comprising from 1 to 40 carbon atoms. This hydrocarbon chain may be interrupted by one or more heteroatoms, preferably —O— or —S—, and/or by one or more groups of the type —SO₂, —SO—, —NHC(O)—, —OC(O)—, —NH and —NH—CO—NH—. In an additional or alternative manner, said hydrocarbon chain may be substituted by one or more groups, preferably selected from —OR₅, —N(R₅)₂, —CF₃ and a C₁-C₆ alkyl, a monosaccharide or a disaccharide. In certain embodiments, the vectorization moiety is an oligo- or polyether-type moiety, for example a polyethylene glycol, a polypropylene glycol or a polytetramethylene glycol. In certain embodiments, L comprises or consists of —(CH₂—CH₂—O)ₙ—CH₂—CH₂—OH where n is an integer ranging from 1 to 19.

In certain embodiments, the compound of formula (I) is characterized in that:
R₁, R₂, R₃ and R₄ are independently selected from the group consisting of a hydrogen, a halogen, preferably —Cl or —F, —OH, —O(CO)—CH₃, —OCH₃, —NH₂, CF₃ and —CN
X and Y are O,
M is Bi or Cu, and
L is H, a C₁-C₆ hydroxyalkyl, a glycosyl radical or an oligo or polyether chain such as —(CH₂—CH₂—O)ₙ—CH₂—CH₂—OH where n is an integer ranging from 1 to 19.

In a particular embodiment, the compound of formula (I) is characterized in that:
R₁ and R₃ are —H,
R₂ and R₄ are independently selected from the group consisting of —H, —Cl, —F, —OH, —O(CO)—CH₃, —OCH₃, —NH₂ and —CN. Preferably, R₂ and R₄ are selected from —H, —Cl or —F,
X and Y are O,
M is Bi or Cu, preferably Bi, and
L is H, a C₁-C₆ hydroxyalkyl, a glycosyl radical or an oligo or polyether chain such as —(CH₂—CH₂—O)ₙ—CH₂—CH₂—OH where n is an integer ranging from 1 to 19.

In another embodiment, the compound of formula (I) is characterized in that:
R₁ and R₃ are —H,
R₂ and R₄ are independently selected from —H, —Cl and —F,
X and Y are O,
M is Cu or Bi, preferably Bi, and
L is H, a C₁-C₆ hydroxyalkyl, or —(CH₂—CH₂—O)ₙ—CH₂—CH₂—OH where n is an integer ranging from 1 to 19, preferably from 1 to 10.

Preferred compounds according to the invention are the compounds of formula (Ia):

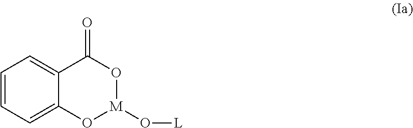

where M and L are as defined above.

### Preferably:

M is Bi, and
L is H, a C₁-C₆ hydroxyalkyl, or —(CH₂—CH₂—O)ₙ—CH₂—CH₂—OH where n is an integer ranging from 1 to 19, preferably from 1 to 10.

In certain embodiments, the compounds of formula (Ia) are such that L=H and M=Bi or Cu.

The compounds of formula (I) may be prepared by chemical synthesis as illustrated in Timakova et al., Chemistry for Sustainable Development, 2009, 305-313.

The compounds according to the invention may be used for treating any fungal disease affecting plants described in the present description.

The compounds according to the invention may be used for treating or preventing pathologies of the wood and of the roots, but also those developing in the aerial parts of the plant such as the fruits, the leaves, the stems, the ears, the flowers and the panicles.

The symptoms caused by fungal diseases which develop in the aerial parts of plants are varied and comprise, among other things, spots, for example black, brown or yellowish spots, burning or necrosis of the leaves, stems or seeds, damping off, the appearance of pycnidia, the appearance of pustules on the leaves, leaf dieback phenomena, drying notably of the leaves, leaf chlorosis or discoloration, the appearance of perithecia on the stems, or of fruit molds and dieback.

By way of example of fungal diseases, mention may be made of:
Alternariosis caused by fungi of the genus Alternaria. Mention may be made of alternariosis of beet (Alternaria alternata), of carrot (Alternaria dauci), of crucifers (Alternaria brassicicola, Alternaria brassicae), of Solanaceae (Alternaria solani) or of wheat (Alternaria triticina).
Fusariosis caused, notably, by phytopathogens of the genus Fusarium, which, depending on the plant species affected, may appear as lesions and/or brown staining of the seeds and stems as well as the appearance of dry rot. By way of example, mention may be made of the species Fusarium graminearum and Fusarium nivale which affect wheat, or Fusarium sambucinum which affects potato. Mention may also be made of fusariosis of sugarcane.
Septoriosis caused by phytopathogens of the family Mycosphaerellaceae, particularly of the genus Septoria. By way of example, mention may be made of septoriosis of carrot (Septoria dauci), of tomato (Septoria lycopersici) or of wheat (Septoria tritici).
Verticilliosis caused by phytopathogens of the genus Verticillium, notably by Verticillium dahliae and Verticillium albo-atrum, and which can affect various types of herbaceous plants such as tomato or eggplant.
Pyriculariosis which affects mainly rice and is caused by Magnaporthe grisea.
Brown rot caused by phytopathogens of the genus Monihnia and which affect mainly fruit trees. By way of example, mention may be made of phytopathogenic Monihnia fructigena, which attacks mainly pome fruits, and Monihnia laxa, which affects mainly stone fruits.
Fruit rot and mold diseases caused notably by Penicillium digitatum, Aspergillus niger or Botrytis cinerea.
Cercosporiosis caused by fungi of the imperfect genus Cercospora or by the genus Mycosphaerella. Mention may be made of cercosporiosis of beet (Cercospora beticola), or cercosporiosis of corn (Cercospora zeae-maydis and Cercospora zeina). Black cercosporiosis is a leaf disease of the banana tree which is caused by Mycosphaerella fijiensis.
Helminthosporiosis caused notably by the genus Bipolaris and which affects mainly grasses. Mention may be made of rice helminthosporiosis caused by Bipolaris oryzae, corn helminthosporiosis caused by Bipolaris maydis and Bipolaris zeicola, cereal helminthosporiosis caused by Bipolaris sorokiniana.
Rust caused by parasitic fungi of the order Pucciniales. By way of example, mention may be made of coffee rust caused by the basidiomycetes fungi Hemileia vastatrix and Hemileia coffeicola.
Take-all disease, which affects mainly cereals and other grasses, such as wheat, barley and rye. Contamination occurs on the roots and the symptoms are visible on the stem, the roots (blackening and necrosis) and the ears (bleaching). This disease causes damping off. Take-all disease is caused mainly by Gaeumannomyces graminis.

In certain embodiments, the fungal pathology affecting the aerial parts may also comprise rot and mold diseases of the fruit or leaves such as gray rot, black rot (also known as dry rot), and Macrophoma rot. These pathologies may involve various types of fungi. By way of example, the phytopathogenic fungi affecting the leaves, the fruits, the berries and/or the flowers, notably in grapevines, include, but are not limited to, Guignardia bidwellii (also known as Botryosphaeria bidwellii) (black rot), Botryosphaeria dothidea (Macrophoma rot) and Botrytis cinerea (gray rot).

In certain embodiments, the fungal disease may be selected from the group consisting of alternariosis, fusariosis, septoriosis, verticilliosis, pyriculariosis, brown rot, rust caused by parasitic fungi of the order Pucciniales, cercosporiosis, helminthosporiosis, take-all disease, rot and mold diseases of the fruit, notably gray rot, black rot and Macrophoma rot.

In another embodiment, the fungal pathology is associated with or caused by a phytopathogenic fungus selected from the group consisting of Verticillium dahliae, Verticillium albo-atrum, Magnaporthe grisea, Monilinia fructigena, Monilinia laxa, Penicillium digitatum, Aspergillus niger, Botrytis cinerea, Septoria dauci, Septoria lycopersici, Septoria tritici, Fusarium graminearum, Fusarium nivale, Alternaria triticina, Alternaria alternata, Alternaria dauci, Alternaria solani, Alternaria brassicicola, Alternaria brassicae, Guignardia bidwellii, Botryosphaeria dothidea, Botrytis cinerea, Cercospora beticola, Cercospora zeae-maydis, Cercospora zeina, Mycosphaerella fijiensis, Bipolaris oryzae, Bipolaris maydis, Bipolaris zeicola, Bipolaris sorokiniana, Gaeumannomyces graminis, Hemileia vastatrix and Hemileia coffeicola.

In another embodiment, the compounds of formula (I) are used for preventing or treating a rot or mold disease of the fruit and/or leaves, particularly of grapevine. In certain embodiments, said disease is associated with one or more pathogens selected from the family Botryosphaeriaceae and the genus Botrytis, notably Botrytis cinerea. Preferably, the treated plant is a crop of agronomic interest. By way of example, the treated plant may be selected from grapevines, strawberry plants, tomato, sunflower and fruit trees.

In the context of the fungal diseases involving contamination of the aerial parts of the plant such as the leaves and fruits, the compound according to the invention may be administered during periods of leaf development, flowering and fruit maturation, for example in the form of a sprayable solution, directly on the fruits and/or leaves.

According to a particular aspect, the compound of formula (I) may be used for preventing or treating rot or mold in crop products. By “crop products” is meant products which are picked or harvested, particularly vegetables, fruits, flowers or seeds. Fruits include, but are not limited to, bunches of grapes or of currants, berries such as blackberries and raspberries, strawberries, pome fruits such as apples, citrus, tomatoes and pears, stone fruits, notably cherries, peaches, nectarines, plums, apricots, avocados or mangos. More precisely, the compound of formula (I) may be used as a preservative for packaging and storing harvest products. Typically, the compound according to the invention may be applied to the harvested products, before or during packaging, by spraying.

Fungal wood pathologies include the so-called “dieback” diseases such as esca, Botryosphaeria dieback, in particular black dead arm, Diplodia-cane dieback or Botryosphaeria canker, Eutypa dieback, anthracnose and dead-arm disease. These diseases are associated with one or more pathogens such as those belonging to the family Botryosphaeriaceae.

Esca, Eutypa dieback and black dead arm are the main wood diseases affecting grapevines. These diseases, among others, are described in Bertsch et al., Plant Pathology, 2013, 1-23, the contents of which are incorporated herein by reference.

Wood pathologies are caused by various types of fungal pathogens. By way of example, mention may be made of the pathogens belonging to the family Botryosphaeriaceae, in particular to the genera Spencermatinsia, Neofusicoccum, Botryosphaeria, Diplodia and Lasiodiplodia, the pathogens belonging to the genus Eutypa, for example Eutypa lata, or the pathogens belonging to the genera Phaeomoniella, Phaeoacremonium, Formitiporia, Verticillium or Phomopsis such as P. viticola. Phaeomoniella chlamydospora, Phaeoacremonium aleophilum, Eutypa lata, Fomitiporia mediterranea, Fomitiporia punctata, Botryosphaeria stevensii, Diplodia seriata, Neofusicoccum parvum, Stereum hirsutum and Verticillium longisporum are particularly involved in grapevine wood dieback diseases. By way of example, Eutypa lata is the principal pathogenic agent of Eutypa dieback. Neofusicoccum parvum is notably associated with Botryosphaeria dieback, notably with black dead arm. Esca is generally associated with Phaeomoniella chlamydospora, Phaeoacremonium aleophilum and Fomitiporia mediterranea, as well as Eutypa lata.

According to an additional aspect, the present invention has as an object the use of a compound of formula (I) for preventing or treating a wood disease associated with one or more pathogens selected from Phaeomoniella chlamydospora, Phaeoacremonium aleophilum, Eutypa lata, Fomitiporia punctata, Botryosphaeria stevensii, Fomitiporia mediterranea, Diplodia seriata, Neofusicoccum parvum, Stereum hirsutum and Verticillium longisporum.

More generally, a compound of formula (I) may be used for preventing, treating or slowing down the colonization or the infection of a plant by a pathogen selected from Phaeomoniella chlamydospora, Phaeoacremonium aleophilum, Eutypa lata, Fomitiporia mediterranea, Fomitiporia punctata, Botryosphaeria stevensii, Diplodia seriata, Neofusicoccum parvum, Stereum hirsutum and Verticillium longisporum.

For treating or preventing wood diseases, the compound according to the invention may be administered on part of the infected plant, the potentially infected plant, or the plant exhibiting symptoms, for example on part of the trunk, the base, the boughs or the branches. Alternatively, the compound according to the invention may also be applied to the leaves (for example on the underside of the leaves), the flowers or the fruits, particularly when systemic administration is sought.

In the context of fruit trees, grapevines or ornamental or horticultural plants, contamination by pathogenic agents responsible for wood diseases may follow the pruning of the plants. Plant pruning may take place during the vegetative period but also during the “green” period (such as disbudding, leaf removal, secondary branch removal, trimming or thinning out). Thus, in a particular embodiment, the compound of formula (I) may be used for preventing or treating infections of pruning wounds, notably in grapevine crops, fruit tree crops such as apricot trees, mango trees, plum trees, peach trees, apple trees, pear trees, cherry trees, quince trees, walnut trees, fig trees and citrus trees, rosebush crops, or horticultural and ornamental perennial plants. In this embodiment, the compound of formula (I) may be administered to the plant at the time of pruning, in the form of a composition of any type, for example in the form of a sprayable solution or in the form of a paste, a gel, an insert or a solution that can be brushed directly on the pruning wounds or injected into the wood.

According to a particular aspect, the compound of formula (I) may be used for treating or preventing wood necrosis or for slowing down development thereof in a woody plant, said necrosis being associated with a pathogen of the family Botryosphaeriaceae, notably Neofusicoccum parvum. Preferably the woody plant is a tree, for example a fruit tree, such as an olive tree, a mango tree or a eucalyptus tree, a shrub such as a blueberry bush, or a grapevine. As mentioned above, the compound according to the invention may be used for preventing or treating necrosis of a pruning wound.

According to another aspect, the compounds according to the invention may also be used during the preparation of seedlings in a nursery, as a disinfecting agent. In particular, they may be used for disinfecting propagation material or seedlings leaving the nursery, before they are planted in the field.

According to a particular aspect, the present invention has as an object the use of a compound of formula (I) for preventing or treating a disease, preferably a fungal disease, of grapevines. Within the meaning of the invention, the term “grapevine” includes all species belonging to the genus Vitis, notably those belonging to the subgenus Muscadinia, such as V. rotundifolia or V. munsoniana, and those belonging to the subgenus Euvitis including the American species, such as V. berlandieri, V. riparia, V. rupestris, V. cinerea or Vitis labrusca, the Asian species, such as V. amurensis and V. coignetiae, and the Eurasian species V. vinifera L., which is the most cultivated species in Europe and in the world.

The grapevine fungal disease may be either a wood disease, for example esca, a Botryosphaeria dieback disease such as black dead arm, Eutypa dieback, anthracnose and dead-arm disease, or a disease affecting the leaves or berries such as black rot, Macrophoma rot or gray rot.

Preferably, it is a fungal disease selected from gray rot, Botryosphaeria dieback, notably black dead arm, and esca. More generally, the compounds of formula (I) may be used for preventing or treating a fungal disease of grapevines involving a pathogen belonging to the genus Botrytis or to the family Botryosphaeriaceae, preferably Botrytis cinerea or Neofusicoccum parvum.

For treating or preventing diseases affecting the aerial parts of the grapevine such as black rot, Macrophoma rot or gray rot, it is preferable to treat the grapevines at the end of the vegetative period, and/or during the periods of leaf development, flowering and/or fruit maturation. Typically, the compounds according to the invention may be applied in solution form, for example by spraying on the grapevines.

For treating or preventing grapevine wood diseases, the compound may be used in a nursery, during the preparation of seedlings, or at the time of or preparatory to pruning.

For example, the compounds of formula (I) may be used for disinfecting propagation or multiplication material, i.e., rootstocks and grafts. The compounds of formula (I) may also be used for treating grafts-cuttings before or after stratification. Alternatively or additionally, the compounds according to the invention may be used for disinfecting seedlings before they are potted or planted in the field. By way of illustration, propagation materials and seedlings may be soaked in a bath containing one or more compounds according to the invention. Typically, it may be an aqueous or hydroalcoholic solution having a concentration ranging between 0.1 mM and 1 M of a compound of formula (I), for example between 1 mM and 500 mM of the compound of formula (I).

If need be, they may be sprayed or brushed in the form of a solution comprising one or more compounds according to the invention. Advantageously, the compounds according to the invention may be used in combination with or as a substitute for the treatments employing hot water or benomyl, captan or didecylmethylammonium chloride baths described in the state of the art.

Needless to say, the compounds according to the invention may also be used for treating in a preventive manner the mother vines of grafts and rootstocks.

As mentioned above, the compounds according to the invention may be used for preventing or treating infections of pruning wounds, particularly infections by N. parvum. To that end, they may be applied before or after pruning, typically just after pruning by spraying, brushing or injection into the wood.

In all the uses as described above, the preferred compounds according to the invention are the compounds of formula (Ia) and, particularly, bismuth subsalicylate.

Generally, the compounds of formula (I) are preferably formulated in a phytopharmaceutical composition before being used. Thus, the present invention also has as an object a phytopharmaceutical composition comprising a compound of formula (I) and at least one phytopharmaceutically acceptable excipient. It goes without saying that the phytopharmaceutical composition according to the invention is intended and suitable for use in treating or preventing a disease, preferably a fungal disease, in a plant. In other words, the phytopharmaceutical composition is characterized by a galenic form and a content of the compound of formula (I) suited to administration in a plant. It goes without saying that the compound of formula (I) is present as an active ingredient in the phytopharmaceutical composition according to the invention.

The phytopharmaceutical composition may comprise one or more compounds of formula (I). The preferred compounds are the compounds of formula (Ia) and, particularly, bismuth subsalicylate.

The phytopharmaceutical composition may be of any type. It may be an aqueous or hydroalcoholic solution, a paste, a gel, in particular an aqueous gel (or hydrogel), a glue, a foam, a water-in-oil or oil-in-water emulsion, a multiple emulsion, a microemulsion or nanoemulsion, a micellar solution, a suspension or a colloid. The phytopharmaceutical composition may also be solid, for example in the form of powder or granules that can be applied directly by “dusting” or that must be dissolved or dispersed in a suitable solvent before application.

The phytopharmaceutical composition may also appear in the form of an insert or implant intended to be inserted in the wood, in particular in part of the wood of the plant infected by the pathogen. The phytopharmaceutical composition may in this case appear in the form of a polymer matrix allowing controlled release of the compound of formula (I) in the wood.

The phytopharmaceutical composition according to the invention comprises generally from 0.01% to 50% by weight of the compound of formula (I) and from 50% to 99.99% by weight of one or more phytosanitarily acceptable excipients, the weight percentages being expressed in relation to the total weight of the composition. Preferably, the phytopharmaceutical composition according to the invention comprises generally from 0.1% to 30% by weight of the compound of formula I and from 70% to 99.9% by weight of one or more excipients.

By “phytosanitarily or phytopharmaceutically acceptable excipient” is meant an excipient which has no notable toxicity, at the concentration at which it is used, to the plant, to the environment and to humans. The excipients which may be used in the phytopharmaceutical compositions are well-known to the person skilled in the art and include, among others, diluents and fillers, wetting agents, surfactants, for example ionic, amphoteric or nonionic surfactants, dispersants, thickeners, gelling agents, agents allowing controlled release of the active agents, for example encapsulation or micellar agents such as phospholipids, thixotropic additives, dyes, antioxidants, preservatives, stabilizers, film-forming agents, carriers, particularly solvents such as water and the lower alcohols, oils of mineral, plant or animal origin, resins, waxes, rosin, latexes, gums such as gum arabic, antifoaming agents and adhesive agents.

In a preferred embodiment, the composition according to the invention comprises an excipient selected from a filler or a diluent, a thickener, a carrier and a surfactant.

By way of example of a filler or a diluent, mention may be made of clays, silicates, for example magnesium or aluminum silicates, kaolin, talc, quartz, attapulgite, montmorillonite, bentonite, diatomaceous earth, silica, alumina, pumice stone, dolomite, cellulose and derivatives thereof, starch and derivatives thereof, and mixtures thereof.

By way of example of a carrier, mention may be made of water, alcohols, particularly butanol or a glycol, organic solvents, mineral oils such as petroleum jelly and paraffin oil, vegetable oils, for example rapeseed or sunflower oil, and mixtures thereof.

The surfactant may be an emulsifier, a dispersant or a wetting agent of ionic or nonionic type or a mixture of such surfactants. Among these, mention may be made, for example, of polyacrylic acid salts, lignosulfonic acid salts, phenolsulfonic acid salts or naphthalenesulfonic acid salts, condensation polymers of ethylene oxide with fatty alcohols, fatty acids or fatty amines, substituted phenols (in particular alkylphenols), taurine derivatives (in particular alkylated derivatives), phosphoric esters of alcohols or of condensation polymers of ethylene oxide with phenols, esters of fatty acids with polyols, or sulfate, sulfonate or phosphate functional derivatives of these compounds. Surfactants also comprise compounds such as alkyl polyglycosides, fatty acid sucroglycerides, the copolymers vinylpyrrolidone-vinyl acetate, vinylpyrrolidone-ethyl methacrylate, methyl vinyl ether-maleic anhydride, or phospholipids. The presence of at least one surfactant may be necessary when the active ingredient and/or the filler are only slightly soluble or are not soluble in the carrier used, for example water.

As a suitable thickener, mention may be made of alumina hydrate, magnesium hydroxide, bentonite-type clays and colloidal silica, albumin, milk casein, starchy material, for example cornstarch, plant gums, for example gum arabic, xanthan gum and tragacanth gum, starch derivatives, alginates, carrageenans, cellulose ethers such as methyl celluloses, carboxymethyl celluloses, methyl hydroxyethyl celluloses, hydroxyethyl celluloses and hydroxypropyl methylcelluloses, polyvinyl alcohols, polyacrylic acids and mixtures thereof.

Preferably, the phytopharmaceutical composition according to the invention comprises at least one excipient selected from anionic or nonionic emulsifiers and mineral or vegetable oils.

By way of example, one or more excipients, in particular one or more surfactants, recommended by the ITCF (French Technical Institute for Cereals and Fodder), may be used. The phytopharmaceutical composition according to the invention may further comprise one or more additional phytosanitary or phytopharmaceutical agents. The additional phytosanitary or phytopharmaceutical agent(s) may be selected from pesticides, bactericides, fungal agents, virucides, growth regulators, plant natural defense stimulators such as elicitors, etc.

The elicitor agent may be a compound such as laminarin, oligogalacturonides or chitin.

The additional fungicide may be selected, for example, from fenhexamid, fluopyram, trifloxystrobin, spiroxamine, epoxiconazole, pyraclostrobin, mancozeb, cymoxanil, fosetyl-aluminum, folpet, tetraconazole, tebuconazole, copper sulfate, chlorothalonil, kiralaxyl, fenpropimorph, cyazofamid, ametoctradin, metiram, dithianon and dimethomorph.

The phytopharmaceutical composition according to the invention may, additionally or alternatively, comprise one or more compounds selected from fertilizers and fertilizing agents. The phytopharmaceutical composition according to the invention may be prepared by methods well-known to the person skilled in the art, for example by mixing a compound of formula (I) with one or more excipients and, optionally, one or more additional phytosanitary agents.

The galenic form and the excipients of the phytopharmaceutical composition according to the present invention depend on the treated disease and/or the desired mode of administration.

The modes of administration according to the invention include spraying, dusting, injection in the wood or in the zones of wood necrosis, brushing or spreading, notably on pruning wounds. It may also be administered by immersion, for example for treating propagation material and seedlings. The mode of administration may also rest on introducing an insert into the wood or the wood necrosis. If need be, the compound or the composition according to the invention may be administered in the water used to irrigate the plant.

By way of illustration, a phytopharmaceutical composition according to the invention may be a sprayable solution comprising:
1% to 5% of a compound of formula (I),
1% to 10% of a surfactant, for example a lecithin,
85% to 98% of a carrier, preferably water,
optionally, 1% to 20% of a film-forming agent, preferably a mineral oil, a polysaccharide,
optionally, 0.1% to 5% of an additional phytopharmaceutical agent, preferably a fungicide. Such a solution is preferably diluted by a factor of 2 to 10 before application.

The frequency, the amount and the period of administration of the compound or the composition according to the invention depend on the fungal disease to be treated or prevented as well as the type of plant or crop to be treated.

By way of example, it may be estimated that the amount of the compound (I) administered per treatment is between 1 g and 1 kg per ha of crop, preferably 5 g to 1 kg per ha of crop (for example a grapevine crop).

For preventing or treating a disease of the aerial parts of the plant such as gray rot or black rot, the phytopharmaceutical composition according to the invention may be used on a crop such as an orchard or a vineyard, at a rate of at least once per month, for example once every three weeks, once every two weeks, or once per week. The phytopharmaceutical composition is preferably applied to the leaves and/or fruit by spraying. The treatment cycle may begin during the period of leaf development and end when the fruits or bunches are harvested.

To prevent infections of pruning wounds, the crop may be treated before, during and/or after pruning, preferably before and after pruning. For example, the plants (e.g., grapevines or fruit trees) may be treated by spraying with a phytopharmaceutical composition according to the invention in the 48, 24 or 12 hours preceding pruning, even in the hour prior to pruning. The plants may be treated again in the 24 or 48 hours following pruning, preferably by spraying or brushing a phytopharmaceutical composition according to the invention. The treatment may be repeated as many times as necessary, for example at a rate of once every two weeks.

It is also possible to apply the phytopharmaceutical composition according to the invention simultaneous to pruning, for example using a device making it possible both to cut and to distribute the phytopharmaceutical composition according to the invention. In this embodiment, the phytopharmaceutical composition according to the invention is advantageously in the form of a liquid or gelled solution.

By way of an additional exemplary implementation of the invention, a grapevine trunk exhibiting necrosis, for example necrosis typical of esca, Eutypa dieback or Botryosphaeria dieback, may be treated by applying directly to the zone of necrosis the phytopharmaceutical composition according to the invention, wherein said composition may be in paste form.

According to an additional aspect, the present invention also has as an object a method for treating or preventing a disease, preferably a fungal disease in a plant, said method comprising applying a compound of formula (I) or a phytopharmaceutical composition as defined above on at least a part of said plant.

Needless to say, this method may be implemented according to any one of the conditions described above.

The present invention also has as an object a method for disinfecting the multiplication material used during the preparation of seedlings, or of a seedling leaving a nursery, said method comprising applying a compound of formula (I) or a phytopharmaceutical composition according to the invention on the multiplication material or the seedling, preferably by immersion.

Lastly, the invention also has as an object a method for preventing or treating rot or mold in harvest products, said method comprising applying a compound of formula (I) or a phytopharmaceutical composition as defined above on said harvest products.

This application may be carried out, for example, by spraying, before or during packaging of the harvest products.

Other aspects and advantages of the present invention will appear from reading the following examples, which should be regarded as illustrative and as in no case limiting the scope of the invention.

### EXAMPLES

### Example 1: Study of the Mycelial Growth of N. parvum Isolate Bourgogne S-116 on Various Supplemented Culture Media-Evaluation of the Biocidal Activity of Bismuth Subsalicylate

Protocol

The fungus N. parvum Bourgogne is grown on solid potato dextrose agar (PDA, 20 g/L) supplemented with bismuth citrate (C₆H₇BiO₄-MM=398.08 g/mol), bismuth oxide (Bi₂O₃-MM=465.95 g/mol), bismuth subsalicylate (C₇H₅BiO₄-MM=362.09 g/mol), copper oxide (CuO-MM=79.54 g/mol-“antifungal action” control) or antimony oxide (O₃Sb₂-MM=291.5 g/mol).

Various concentrations of product were tested: 0, 0.05, 0.1, 0.2, 0.5, 1, 2, 5 and 10 g/L, or from 0 to 125 mM depending on the compound tested.

A circular plug (diameter of 7 mm) of 10-day-old mycelium is deposited sterilely in the center of each Petri dish. The Petri dishes are then incubated at 25° C. in the dark and mycelial growth (in mm) is measured every 24 hours until saturation of the control dish containing no supplement, or 5 days. Three technical and biological repetitions were carried out during this test.

Results

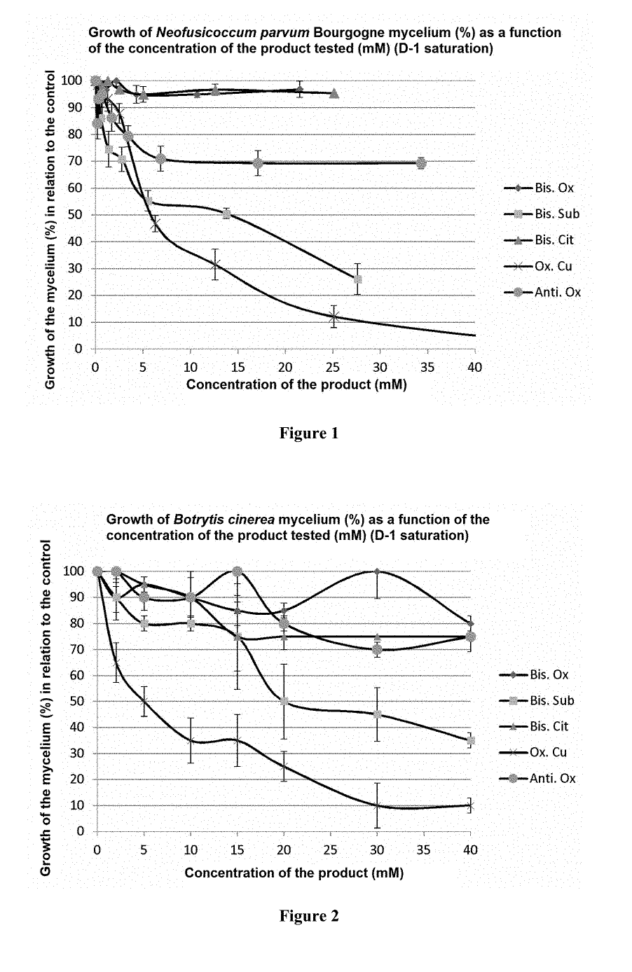

FIG. 1 shows the results at Day-1 of mycelial saturation on the “control” dishes, or after 4 days. They are expressed as the mean percentage (±standard deviation) of mycelial growth in relation to the controls (100%).

The media containing bismuth oxide, bismuth citrate or antimony oxide do not significantly inhibit the growth of the fungus on the culture medium.

Copper oxide, which is the positive control for inhibition of fungal growth, has a low-dose inhibitory effect, and an LD₅₀ of the fungus is observed starting at 5 mM. In comparison with this chemical compound, bismuth subsalicylate significantly inhibits mycelial growth, with a mycelial growth inhibition LD₅₀ starting at 14 mM when it is added to the traditional fungus culture medium.

### Example 2: Study of the Mycelial Growth of B. cinerea B0510 on Various Supplemented Culture Media-Evaluation of the Biocidal Activity of Bismuth Subsalicylate

Protocol

These experiments were carried out under the same conditions as in Example 1 and we also tested the influence of salicylic acid (C₇H₆O₃-MM=138.12 g/mol) in the B. cinerea culture medium. It should be noted that mycelial saturation of the control dishes occurs after 9 days with B. cinerea B0510.

Results

FIG. 2 presents the results obtained at Day-1 of mycelial saturation on the “control” dishes, or after 8 days. They are expressed as the mean percentage (±standard deviation) of mycelial growth in relation to the controls (100%).

The media containing bismuth oxide, bismuth citrate or antimony oxide do not significantly inhibit the growth of the fungus on the culture medium.

Copper oxide, which is the positive control for inhibition of fungal growth, has a low-dose inhibitory effect, and an LD₅₀ of the fungus is observed starting at 5 mM. Bismuth subsalicylate also inhibits the mycelial development of B. cinerea with an LD₅₀ starting at 20 mM.

### Example 3: Study of the Development of Necrosis in Grapevine Wood (V. vinifera L. cv. Chardonnay) Infected by N. parvum Isolate Bourgogne S-116 after Bath Treatment with Various Chemical Compounds (14 dpi)

Protocol

Green internodes of V. vinifera L. cv. Chardonnay are bored using a drill with a diameter of 5 mm. Each bored internode is then immersed for 10 minutes in a water bath (negative control) or a bath containing 15 mM bismuth oxide, salicylic acid or bismuth subsalicylate. A plug (diameter of 5 mm) of N. parvum isolate Bourgogne mycelium or of malt medium (control) is then introduced into the internode and then covered with parafilm. The internodes are then incubated at 25° C. in the dark at a humidity of about 70% for 14 days. Following these 14 days of inoculation, the surface layer of wood is removed from the internodes and then the areas of necrosis are calculated using the ImageJ® software.

The results are expressed as the mean percentage (±standard deviation) of areas of necrosis observed on the internodes. Three biological repetitions, each comprising seven technical repetitions per treatment, were carried out during this test. Duncan's statistical test (with p≦0.05) was applied in order to compared the treatments.

Results

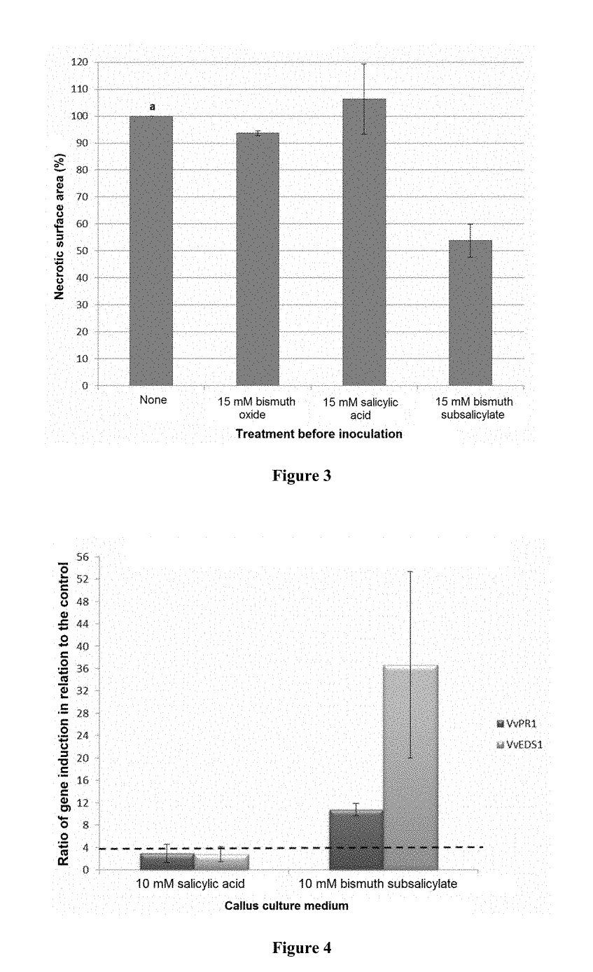

FIG. 3 presents the results obtained for each bath tested. Notably, treatment with 15 mM salicylic acid does not significantly inhibit the development of necrosis on the inoculated internodes. Bismuth oxide treatment decreases the necrotic area by only 5%. On the other hand, pretreatment with 15 mM bismuth subsalicylate makes it possible to prevent the development of necrosis in a significant manner compared with the control samples, since an almost 50% reduction in the surface area of the necrotic lesions is observed.

Pretreatment of the internodes consisting of a 10-minute bath in 15 mM bismuth subsalicylate thus substantially and significantly inhibits the growth of the fungus in the wood and thus the formation of necrosis.

### Example 4: Evaluation of the Phytotoxicity of Bismuth Subsalicylate on Grapevine Cell Clusters (V. vinifera L. cv. Chardonnay)

Protocol

Calli (or undifferentiated cell clusters) of V. vinifera cv. Chardonnay are obtained from anthers as described in Mauro et al. (1986) and in Bertsch et al. (2005).

All the calli are inoculated on fresh solid MPM1 medium (Perrin et al. 2004) every 3 weeks and incubated at 25±0.5° C. in the dark with a relative humidity of 70±10%.

For this experiment, we supplemented the callus culture medium with 0.5 or 10 mM bismuth subsalicylate, bismuth oxide or salicylic acid.

This experiment was repeated three times. For each condition, 15 white-yellow calli, with a diameter of 10±2 mm, were used.

Calli growth in each condition tested is evaluated by weighing each day for 5 days. Duncan's statistical test (with p≦0.05) was applied to the means and standard deviations of the results thus obtained. In addition to weighing, we visually evaluate the appearance and color of the calli according to their culture medium for 2 months.

Results

The results after 5 days of culture indicate that there is neither significant inhibition of nor increase in the growth of the calli on the various culture media tested.

With regard to the appearance and color of the calli, there is no change on the media supplemented with 5 and 10 mM bismuth oxide. We observe a light grayish coloring at the periphery of the calli but no necrosis is noted on the media supplemented with 5 or 10 mM bismuth subsalicylate or salicylic acid. After 2 weeks of culture these calli exhibit cell multiplication zones of normal color (yellowish-white) including from the zones having a grayish color after 5 days of culture.

After 3 weeks of culture on supplemented MPM1 medium the calli are reinoculated on fresh pure MPM1 medium. Their appearance, color and growth is similar to those of the controls and all take on a yellowish-white color after 2 months of experimentation. The addition of bismuth subsalicylate thus has no impact in terms of growth, multiplication or necrotic appearance on grapevine cells.

### Example 5: Induction of Plant Defense Genes by Bismuth Subsalicylate and Salicylic Acid in Grapevine Cell Clusters (V. vinifera L. cv. Chardonnay)

Protocol

The calli of Example 4 are taken after 4 days of culture on pure MPM1 medium (control) or on MPM1 medium supplemented with 10 mM salicylic acid or 10 mM bismuth subsalicylate in order to be used for molecular analyses by qRT-PCR as described in Ramirez-Suero et al. (2014). Three calli are taken per condition for each experiment.

Once the RNA is extracted from these calli and their cDNA synthesized, we carried out qRT-PCR analyses in accordance with the conditions described in Bénard-Gellon et al. (2014), in order to observe the expression of two specific genes of the salicylic acid pathway: VvPR1 (acquisition temperature=83° C.) and VvEDS1 (acquisition temperature=77° C.). Three technical and biological repetitions are carried out for each sample and each gene tested. The VvACT and VvEF1-Cs genes are used as reference genes to normalize our results. The genes will be deemed overexpressed when the induction ratio of the genes is ≧4. The median expression values and the standard deviations are calculated in accordance with the procedure of Hellemans et al. (2007). Duncan's tests (with p≦0.05, Duncan 1955) and ANOVA multivariate analyses (StatgraphicPlus®, Manugistics, Inc., Maryland, USA) are applied to compare gene expression on each culture medium.

Results

The results are presented in FIG. 4. The molecular analyses by qRT-PCR indicate that the calli grown on medium supplemented with 10 mM salicylic acid or with bismuth subsalicylate overexpress VvPR1 and VvEDS1 genes. Remarkably, these studies of defense gene expression show that bismuth subsalicylate induces overexpression of the genes characteristic of the salicylic acid pathway in cells having been in contact with this product and that this gene overexpression is greater than that observed with salicylic acid.

### Example 6: Evaluation of the Biocidal Activity of Bismuth Subsalicylate on a Panel of 8 Model Fungi

The biocidal activity of bismuth subsalicylate was evaluated on 8 additional model fungi, namely:
Alternaria alternata: alternariosis (or early blight) model microorganism,
Fusarium graminearum: fusariosis model microorganism,
Septoria tritici: microorganism responsible for septoriosis in wheat,
Verticillium dahliae: verticilliosis model microorganism,
Magnaporthe grisea: pyriculariosis model microorganism,
Monilinia laxa: brown rot model microorganism,
Penicillium digitatum: agent responsible for fruit rot, notably citrus rot (green rot),
Black aspergilli (Aspergillus niger): microorganism responsible for the appearance of black mold on fruits and vegetables.

The biocidal activity of the compound was also retested on Botrytis cinerea.

The activity tests were carried out on Petri dishes in agar medium, except for Septoria tritici where a so-called “microwell” technique was used. The biocidal activity of bismuth subsalicylate was evaluated at seven concentrations, namely 1 g/L, 3 g/L, 7 g/L, 9 g/L, 10 g/L and 12.5 g/L. To that end, an aqueous stock solution containing 50 g/mL of compound, 1% (v/v) of MES (10 mM, pH 6) and 3% (v/v) of DMSO was prepared.

Petri Dish Test

The following protocol was performed:

Bismuth subsalicylate was added to the agar culture medium before solidification at the desired concentration. After solidification, a fungal insert or a piece of confetti immersed beforehand in a spore suspension was deposited in the center of each Petri dish, under sterile conditions. The Petri dishes were incubated in a microbiological enclosure at 21° C. Mycelial growth (diameter in cm) proceeded until saturation of the “control” Petri dishes. Each experiment was carried out in triplicate. Mean diameter values were calculated for each experiment, including for the control experiment, i.e., carried out in the absence of bismuth subsalicylate. Efficacy, expressed as a percentage of the compound at a given concentration, was determined according to the following formula:

$$efficacy = \frac{\begin{matrix}Mean ( control diameter ) - \\ Mean ( diameter in the presence of the compound )\end{matrix}}{Mean ( control diameter )} \times 100$$

Efficacy of 100% means that the compound inhibited mycelial growth completely.

The results obtained are presented in Table 1 below:

TABLE 1
Efficacy of bismuth subsalicylate as a function of concentration and
fungal species. The results illustrated in the table above shows that
bismuth subsalicylate is able to block mycelial growth completely in
all the phytopathogens tested, at a concentration of 9 g/L. This
inhibitory effect is even observable for a concentration of 3 g/L in
Alternaria alternata and Fusarium graminearum

| | Bismuth subsalicylate concentration in g/L | | | | | | |
|---|---|---|---|---|---|---|---|
| Phytopathogenic fungi | 1 | 3 | 5 | 7 | 9 | 10 | 12.5 |
| Magnaporthe grisea | 0% | 0% | 100% | 100% | 100% | 100% | 100% |
| Verticillium dahliae | 0% | 0% | 0 | 100% | 100% | 100% | 100% |
| Penicillium digitatum | 0 | 0% | 100% | 100% | 100% | 100% | 100% |
| Black aspergilli | 0% | 0% | 0% | 36 | 100% | 100% | 100% |
| Botrytis cinerea | 0% | 39% | 100% | 100% | 100% | 100% | 100% |
| Alternaria alternata | 32 | 100% | 100% | 100% | 100% | 100% | 100% |
| Fusarium | 0% | 100% | 100% | 100% | 100% | 100% | 100% |
| graminearum | | | | | | | |
| Monilialaxa | 0% | 0% | 100% | 100% | 100% | 100% | 100% |

Fusarium graminearum.

Microwell Test

The biocidal activity of bismuth subsalicylate was also tested on Septoria tritici using a microwell test. The following protocol was performed:

Bismuth subsalicylate was added to the culture medium. The medium was then inoculated with a suspension of Septoria tritici spores. The microwells were incubated in a microbiological enclosure at 21° C. Each experiment was carried out three times. For each microwell, the number of colonies formed (CFU) was determined. Mean CFU values were calculated for each experiment and for the control experiment carried out in the absence of bismuth subsalicylate. The percentage efficacy of the compound at a given concentration was determined according to the following formula:

$$efficacy = \frac{\begin{matrix}Mean ( CFU control ) - \\ Mean ( CFU in the presence of the compound )\end{matrix}}{Mean ( CFU control )} \times 100$$

Efficacy of 100% means thai ihe compound inhibited colony formation completely (i.e., no colony formed).

The results are presented in Table 2 below:

TABLE 2
Efficacy of bismuth subsalicylate as a function of
concentration in Septoria triticii. It is thus noted that
bismuth subsalicylate inhibits the formation of
Septoria tricitii colonies completely as soon as it is
present in the medium at a concentration of 5 g/L.

| | Bismuth subsalicylate concentration in g/L | | | | | | |
|---|---|---|---|---|---|---|---|
| | 1 | 3 | 5 | 7 | 9 | 10 | 12.5 |
| Septoria tricitii | 0% | 0% | 100% | 100% | 100% | 100% | 100% |

### Example 7: Evaluation of the Potential Biocidal Effect of Bismuth Subsalicylate on Two Oomycetes Microorganisms Responsible for Mildew

Relatively old studies mention that bismuth subsalicylate has a biocidal activity with respect to the pathogenic oomycetes responsible for mildew.

Bismuth subsalicylate was thus tested on two model oomycetes, namely Plasmopora viticola and Phytophtora infestans. This study was carried out on plant discs. An aqueous subsalicylate solution (concentration of 1 g/L to 12.5 g/L) was applied by spraying on all the plant discs, using a spray bench equipped with five nozzles. The application volume was 200 L/ha. Spraying was repeated once. Each experiment was carried out in duplicate on 20 leaf discs. After the incubation period (generally 8 days), an assessment of oomycete colonization and sporulation is carried out under a binocular magnifier. The surface area of the leaf discs colonized by the oomycete and the intensity of sporulation are graded on a scale from 0 to 10. Mean damage on the 10 discs was calculated and used to obtain the efficacy of the method compared with untreated discs. The formula used in the calculation applied is: (Efficacy of the dose d)={[(T−D)/1]*100}, where T is the mean grade of attack on the 10 control discs, and D is that observed on the discs treated with the dose d. The percentage efficacy values for bismuth subsalicylate are as follows (Table 3):

| | Bismuth subsalicylate concentration in g/L | | | | | | |
|---|---|---|---|---|---|---|---|
| Oomycetes | 1 | 3 | 5 | 7 | 9 | 10 | 12.5 |
| Plasmopora viticola | 0% | 0% | 0% | 0% | 0% | 22.5% | 37.5% |
| Phytophtora infestans | 0% | 0% | 0% | 0% | 5.0% | 2.5% | 6.3% |

What emerges from these results is that the biocidal activity of bismuth subsalicylate is very low, indeed negligible, with respect to the oomycetes responsible for mildew. The biocidal action of bismuth subsalicylate is thus specific to phytopathogenic fungi.

### BIBLIOGRAPHICAL REFERENCES CITED IN THE EXPERIMENTAL SECTION

Benard-Gellon M, Farine S, Goddard M L, Schmitt M, Stempien E, Pensec F, Laloue H, Mazet-Kieffer F, Fontaine F, Larignon P, Chong J, Tarnus C, Bertsch C (2014) Toxicity of extracellular proteins from Diplodia seriata and Neofusicoccum parvum involved in grapevine botryosphaeria dieback. Protoplasma doi: 10.1007/s00709-014-0716-y.
Bertsch C, Kieffer F, Maillot P, Farine S, Butterlin G, Merdinoglu D, Walter B (2005) Genetic chimerism of Vitis vinifera cv. Chardonnay 96 is maintained through organogenesis but not somatic embryogenesis. BMC Plant Biology 5:20.
Hellemans J, Mortier G, De Paepe A, Speleman F, Vandesompele J (2007) qBase relative quantification framework and software for management and automated analysis of real-time quantitative PCR data. Genome Biol 8 (2): R19.
Mauro M, Nef C, Fallot J (1986) Stimulation of somatic embryogenesis and plant regeneration from another culture of Vitis vinifera cv. Cabernet-Sauvignon. Plant Cell Reports 5:377-380.
Perrin M, Gertz C, Masson J E (2004) High efficiency of regenerable embryogenic callus from anther filaments of 19-grapevine genotypes grown worldwide. Plant Science 167:1343-1349. Ramirez-Suero M, Bénard-Gellon M, Chong J, Laloue H, Stempien E, Abou-Mansour E, Fontaine F, Larignon P, Mazet-Kieffer F, Farine S, Bertsch C (2014) Extracellular compounds produced by fungi associated with Botryosphaeria dieback induce differential defence gene expression patterns and necrosis in Vitis vinifera cv. Chardonnay cells. Protoplasma. doi: 10.1007/s00709-014-0643-y.
Bertsch C, Ramírez-Suero M, Magnin-Robert M, Larignon P, Chong J, Abou-Mansour E, Spagnolo A, Clément C, Fontaine F (2013) Grapevine trunk diseases: complex and still poorly understood. Plant Pathology 62:243-265.
Andolfi A, Mugnai L, Luque J, Surico G, Cimmino A, Evidente A (2011) Phytotoxins produced by fungi associated with grapevine trunk diseases. Toxins 3:1569-1605.
Úrbez-Torres J R (2011) The status of Botryosphaeriaceae species infecting grapevines. Phytopathol. Mediterr. 50 S5-S45

1-18. (canceled)

19. A method for treating fungal disease or inhibiting fungal growth in a plant, which comprises administering to the plant a compound of formula (I) 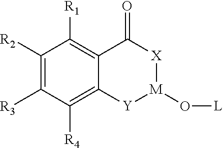
wherein:
R₁, R₂, R₃ and R₄ are independently selected from the group consisting of a hydrogen, a halogen, —OH, —O(CO)CH₃, a C₁-C₆ alkoxy, a C₁-C₆ alkyl, —NH₂ and —CN,
X and Y are independently of each other O, S or NR₅,
M is Bi, Cu or Sb,
L is H or a vectorization moiety comprising from 1 to 40 carbon atoms, and
each R₅ group is independently H or a C₁-C₆ alkyl.

20. The method of claim 19, wherein:
R₁ and R₃ are —H,
R₂ and R₄ are independently selected from —H, —Cl and —F,
X and Y are O,
M is Cu or Bi, and
L is H, a C₁-C₆ hydroxyalkyl, or —(CH₂—CH₂—O)ₙ—CH₂—CH₂—OH where n is an integer ranging from 1 to 19.

21. The method of claim 19, wherein the compound of formula (I) is bismuth subsalicylate:

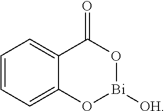

22. The method of claim 19, wherein the fungal disease develops in a wood part of the plant.

23. The method of claim 19, wherein the fungal disease develops in the trunk, the root and/or the stem of the plant.

24. The method of claim 19, wherein the plant is a grapevine.

25. The method of claim 19, wherein the fungal disease is a grapevine trunk disease.

26. The method of claim 25, wherein the fungal disease is selected from the group consisting of esca, Eutypa dieback, Botryosphaeria dieback, black dead aim, black rot, and dead-arm disease.

27. The method of claim 19, wherein the fungal disease develops in a wood part of the plant and is associated with one or several pathogens selected from the group consisting of pathogens belonging to the family Botryosphaeriaceae, pathogens belonging to the genus Eutypa, pathogens belonging to the genus Phaeomoniella, pathogens belonging to the genus Phaeoacremonium, pathogens belonging to the genus Formitoporia, pathogens belonging to the genus Verticillium, pathogens belonging to the genus Stereum and pathogens belonging to the genus Phomopsis.

28. The method of claim 27, wherein the one or several pathogens comprise a pathogenic fungus selected from the group consisting of Phaeomoniella chlamydospora, Phaeoacremonium aleophilum, Eutypa lata, Fomitiporia mediterranea, Fomitiporia punctata, Botryosphaeria stevensii, Diplodia seriata, Neofusicoccum parvum, Stereum hirsutum et Verticillium longisporum.

29. The method of claim 19, wherein the compound of formula (I) is administered to the plant in the form of a phytopharmaceutical composition selected from a solution, a paste, an insert, a gel, a powder or a granule.

30. The method of claim 19, wherein the compound of formula (I) is administered to the plant by spraying or by injection into the wood of the plant.

31. The method of claim 19, wherein the plant suffers from wood necrosis and the compound of formula (I) is administered on or inside the wood necrosis.

32. The method of claim 19, which is for treating or preventing fungal infections of pruning wounds in the plant.

33. A method for disinfecting multiplication material during the preparation of seedlings, which comprises administering the multiplication material with the compound of formula (I) 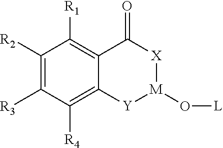
wherein:
R₁, R₂, R₃ and R₄ are independently selected from the group consisting of a hydrogen, a halogen, —OH, —O(CO)CH₃, a C₁-C₆ alkoxy, a C₁-C₆ alkyl, —NH₂ and —CN,
X and Y are independently of each other O, S or NR₅,
M is Bi, Cu or Sb,
L is H or a vectorization moiety comprising from 1 to 40 carbon atoms, and
each R₅ group is independently H or a C₁-C₆ alkyl.

34. A phytopharmaceutical composition comprising:
from 0.01% to 50% by weight of a compound of formula (I) as defined in claim 19, and
from 50% to 99.99% by weight of one or more phytopharmaceutically acceptable excipients,
the weight percentages being expressed in relation to the total weight of the composition of a compound of formula (I).

35. The phytopharmaceutical composition of claim 34, wherein the compound of formula (I) is bismuth subsalicylate and wherein at least one excipient is selected from a filler, a diluent, a thickener, a carrier and a surfactant.
